(19) United States
(12) Patent Application Publication
(10) Pub. No.: US 2026/0359716 A1
(43) Pub. Date: Nov. 12, 2026

(54) SYSTEMS AND METHOD FOR HOSTING TRAINING DATA FOR CONSTRUCTION OF A CLASSIFIER

(71) Applicant: Walmart Apollo, LLC, Bentonville, AR (US)

(72) Inventors: Georgy Melamed, Ramat Gan (IL); Evgeni Pinkovich, Atlit (IL)

(21) Appl. No.: 19/204,048

(22) Filed: May 9, 2025

(51) Int. Cl. G06N 20/00

(52) U.S. Cl. CPC G06N 20/00

(57) ABSTRACT

Example implementations relate to systems and methods for hosting training data for construction of a classifier. In an example, a system receives a majority class dataset and a minority class dataset. The system determines, using a comparator, a most similar instance of the majority class dataset compared to a minority class dataset instance of the minority class dataset. The system determines, using the comparator, a majority class subset based on the most similar instance of the majority class dataset, wherein the majority class subset has a majority class subset size and the majority class subset size is equal to the minority class dataset size. The system trains a classifier based on the majority class subset and the minority class dataset.

### TECHNICAL FIELD

This application relates generally to hosting training data, and more particularly, to hosting training data for construction of a classifier.

### BACKGROUND

Machine learning tools, such as a classifier, may be utilized for classification tasks. Training data utilized during the construction of a classifier may include significant class imbalances, which may result in overfitting based upon spurious and/or sparse training data trends. Overfitting based on these data trends may prevent generalization of the network during construction, deteriorating the performance of the classifier.

### BRIEF DESCRIPTION OF THE DRAWINGS

Various examples will be described below with reference to the following figures.

FIG. 1 depicts an example system for hosting training data for use with a classifier, in accordance with some embodiments.

FIG. 2 depicts an example representation of data classes, in accordance with some embodiments.

FIG. 3 depicts an example representation of training data, in accordance with some embodiments.

FIG. 4 depicts a flow diagram for hosting example training data for use with a classifier, in accordance with some embodiments.

FIG. 5 depicts a flow diagram illustrating an example method for hosting training data for use with a classifier, in accordance with some embodiments.

FIG. 6 depicts an example system with a machine-readable medium that includes instructions for hosting training data for use with a classifier, in accordance with some embodiments.

FIG. 7 depicts an example computer system that implements one or more of the disclosed processes, in accordance with some embodiments.

### DETAILED DESCRIPTION

This description of the example embodiments is intended to be read in connection with the accompanying drawings that are to be considered part of the entire written description. Terms concerning data connections, coupling and the like, such as “connected” and “interconnected,” and/or “in signal communication with” refer to a relationship wherein systems or elements are electrically connected (e.g., wired, wireless, etc.) to one another either directly or indirectly through intervening systems, unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages, or alternative embodiments herein may be assigned to the other claimed objects and vice versa. In other words, claims for the systems may be improved with features described or claimed in the context of the methods. In this case, the functional features of the method are embodied by objective units of the systems. While the present disclosure is susceptible to various modifications and alternative forms, specific embodiments are shown by way of example in the drawings and will be described in detail herein. The objectives and advantages of the claimed subject matter will become more apparent from the following detailed description of these example embodiments in connection with the accompanying drawings.

In various embodiments, a system including a processor and a non-transitory memory storing instructions, that when executed, cause the processor to perform one or more operations for hosting training data for construction of a classifier. The instructions, when executed, cause the processor to receive a majority class dataset having a majority class dataset size. The instructions, when executed, cause the processor to receive a minority class dataset having a minority class dataset size, wherein the minority class dataset size is smaller than the majority class dataset size. The instructions, when executed, cause the processor to determine, using a comparator, a most similar instance of the majority class dataset compared to a minority class dataset instance of the minority class dataset. The instructions, when executed, cause the processor to determine, using the comparator, a majority class subset based on the most similar instance of the majority class dataset, wherein the majority class subset has a majority class subset size and the majority class subset size is equal to the minority class dataset size. The instructions, when executed, cause the processor to train a classifier based on the majority class subset and the minority class dataset.

In various embodiments, a computer-implemented method for hosting training data for construction of a classifier is disclosed. The computer-implemented method includes receiving a majority class dataset having a majority class dataset size. The computer-implemented method includes receiving a minority class dataset having a minority class dataset size, wherein the minority class dataset size is smaller than the majority class dataset size. The computer-implemented method includes determining a most similar instance of the majority class dataset compared to a minority class dataset instance of the minority class dataset. The computer-implemented method includes determining a majority class subset based on the most similar instance of the majority class dataset, wherein the majority class subset has a majority class subset size and the majority class subset size is equal to the minority class dataset size. The computer-implemented method includes training a classifier based on the majority class subset and the minority class dataset.

In various embodiments, a non-transitory computer readable medium having instructions for hosting training data for construction of a classifier is disclosed. The instructions, when executed by at least one processor, cause the at least one device to perform operations including receiving a majority class dataset having a majority class dataset size. The instructions, when executed by at least one processor, cause the at least one device to perform operations including receiving a minority class dataset having a minority class dataset size, wherein the minority class dataset size is smaller than the majority class dataset size. The instructions, when executed by at least one processor, cause the at least one device to perform operations including determining, using a comparator, a most similar instance of the majority class dataset compared to a minority class dataset instance of the minority class dataset. The instructions, when executed by at least one processor, cause the at least one device to perform operations including determining, using the comparator, a majority class subset based on the most similar instances of the majority class dataset, wherein the majority class subset has a majority class subset size and the majority class subset size is equal to the minority class dataset size. The instructions, when executed by at least one processor, cause the at least one device to perform operations including training a classifier based on the majority class subset and the minority class dataset.

In some embodiments, the systems and methods disclosed herein can sample the minority class and determine the most similar majority class samples. In some embodiments, the systems and methods disclosed herein can determine and batch contrastive pairs based on the samples of the minority class and the majority class. In some embodiments, the systems and methods disclosed herein can train or construct the classifier based on the batch of contrastive pairs. In some embodiments, the systems and methods disclosed herein can determine a contrastive loss term for each pair within the batch of contrastive pairs. In some embodiments, the systems and methods disclosed herein can train or construct the classifier based on the contrastive loss term for each pair within the batch of contrastive pairs. In some embodiments, the systems and methods disclosed herein can receive a plurality of minority class datasets, determine the most similar instances of the majority class for each respective minority class dataset instance, determine subsets of the majority class based on the most similar instances to the respective minority classes, and train the classifier based on the plurality of majority class subsets and minority class subsets.

In contrast to certain conventional approaches for preparing training data with class imbalances, the systems and methods disclosed herein can utilize contrastive learning techniques to extract useful training data from datasets with class imbalances. The systems and methods disclosed herein can perform under sampling of the majority class, directed by one or more minority class instances. Advantageously, the chosen samples of the majority classes may be more relevant and effective for training and/or constructing the classifier. Further, the systems and methods disclosed herein can be applied to the construction and/or training of any classifier or classification engine and is not limited by any aspect of a specific use case. Additionally, optimization of the training data or training set as described herein can facilitate faster and better convergence while utilizing fewer data samples, thus utilizing observably less computing processing resources, memory resources, and network resources. In some applications, introduction of relevant “hard negatives” with a minimal amount of spurious data trends may increase performance of classifiers by up to approximately 85% relative to certain conventional training methods. Further, in some applications, adjacency of contrastive gradients can further increase performance of classifiers by up to another 10% relative to certain conventional training methods. Further, in some applications, requiring explicit contrast by loss terms can further increase performance of classifiers by up to another 5% relative to certain conventional training methods.

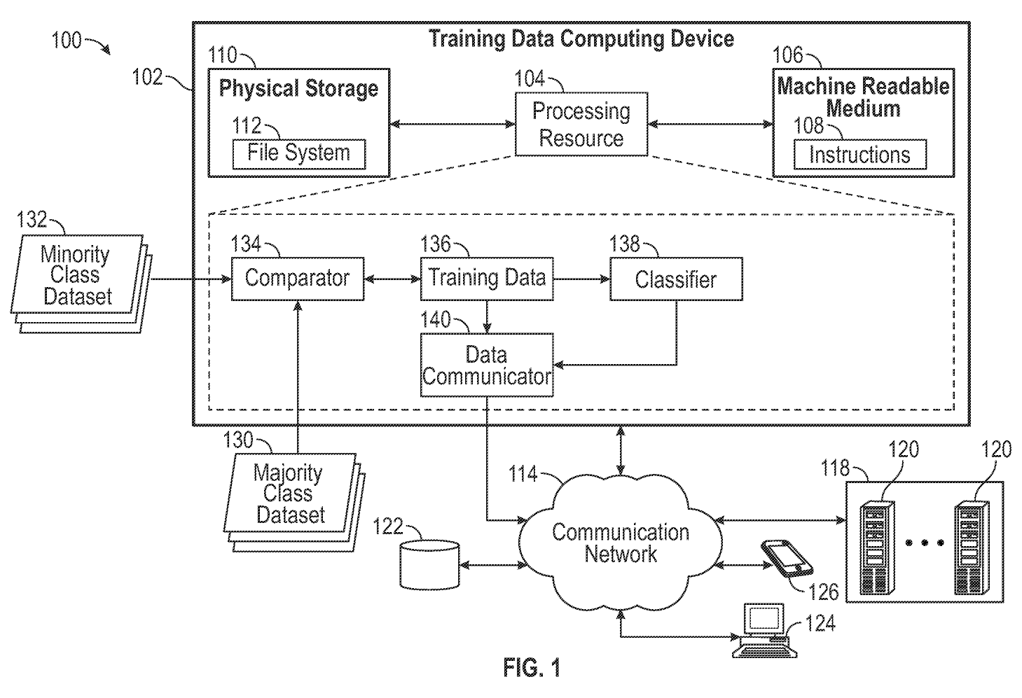

FIG. 1 depicts an example system 100 that hosts training data 136 for construction of a classifier 138, in accordance with some embodiments. The system 100 includes a training data computing device 102 that hosts training data 136 for construction of a classifier 138 based on a majority class dataset 130 and at least one minority class dataset 132. The training data computing device 102 includes a processing resource 104 that may include one or more microcontrollers, microprocessors, field-programmable gate arrays (FPGAs), application-specific integrated circuits (ASICs), state machines, digital circuitry, and/or any other suitable processing resource. The training data computing device 102 includes a non-transitory machine readable medium 106 that may include one or more of a random-access memory (RAM), read-only memory (ROM), electrically erasable programmable read-only memory (EEPROM), flash memory, hard disk, and/or any other suitable memory resource.

The processing resource 104 may execute instructions 108 (i.e., programming or software code) stored on machine readable medium 106 to perform functions of the training data computing device 102, such as determining a most similar instance of the majority class dataset compared to the minority class dataset, determining a majority class subset based on the most similar instances of the majority class dataset, training a classifier based on the majority class subset and the minority class dataset, etc. The instructions 108 may include instructions for implementing one or more models. In some embodiments, and as will be described further herein below, the training data computing device 102 may execute one or more models, processes, or algorithms, such as a machine learning model, deep learning model, statistical model, etc., (e.g., as implemented as machine readable instructions) to host training data.

The training data computing device 102 may also include other hardware components, such as physical storage 110. Physical storage 110 may include any physical storage device, such as a hard disk drive, a solid state drive, or the like, or a plurality of such storage devices (e.g., an array of disks), and may be locally attached (i.e., installed) in the training data computing device 102. In some implementations, physical storage 110 may be accessed as a block storage device.

In some cases, the training data computing device 102 may also include a local file system 112 that may be implemented as a layer on top of the physical storage 110. For example, an operating system may be executing on the training data computing device 102 (by virtue of the processing resource 104 executing certain instructions 108 related to the operating system) and the operating system may provide a file system 112 to store data on the physical storage 110.

The network 114 may include a plurality of devices or systems in communication with the training data computing device 102 over one or more network channels, illustrated as a network cloud. For example, in various embodiments, the training data computing device 102 may be in communication with a web server 116, a cloud-based engine 118 including one or more processing devices 120 that may be provisioned for use, a database 122, a workstation 124, and/or any other suitable system or device. The training data computing device 102 may similarly be in communication, either directly or indirectly, with one or more user computing devices 126 operatively coupled over the network 114. The other computing systems may be similar to the training data computing device 102, and may each include at least a processing resource and a machine readable medium.

In the depicted example, the comparator 134 can determine a degree of similarity or difference between two objects based on a visual, textual, and/or other description of the objects. During operation, the comparator 134 receives a majority class dataset 130 and/or one or more minority class datasets 132 and can select, manipulate, and/or transform the majority class dataset 130 and/or the one or more minority class datasets 132 to identify differences between the datasets and provide effective training data 136 for the construction of the classifier 138. As described herein, the minority class dataset 132 can have a dataset size that is smaller than the dataset size of the majority class dataset 130. In the depicted example, the comparator 134 can utilize a contrastive approach to identify differences between instances of the majority class dataset 130 and/or the one or more instances of the minority class datasets 132.

In the depicted example, the comparator 134 can identify the most generally similar instances of the majority class dataset 130 compared to instances of the minority class dataset 132. In some embodiments, the comparator 134 can compare samples from the minority class dataset 132 to samples from the majority class dataset 130 to find the closest samples from the majority class dataset 130 in embedding space being most relevant for the domain. The identified most generally similar instance of the majority class dataset 130 can result in a subset of the majority class dataset 130 that is the same size as the minority class dataset 132.

In some embodiments, the comparator 134 can provide the subset of the majority class dataset 130 and the minority class dataset 132 as training data 136 to use to train or otherwise construct the classifier 138. In some embodiments, the comparator 134 can provide a plurality of subsets of the majority class dataset 130 that correspond to a plurality of minority class datasets 132. In the depicted example, by providing the subset of majority class dataset 130 and the minority class dataset 132 as training data 136, the comparator 134 can introduce relevant hard negatives. In some embodiments, the training data 136 can allow for pair-wise consideration of candidate samples “hardness”. Advantageously, by utilizing the subset of majority class dataset 130 and the minority class dataset 132 for training (instead of the entirety of the majority class dataset 130 and the minority class dataset 132), the training data 136 may be more balanced. By utilizing balanced training data 136, training of the classifier 138 may avoid converging to a general preference of the majority class dataset 130. Further, by utilizing the subset of majority class dataset 130 and the minority class dataset 132 for training, differentiating features can be identified while spurious features (which may be mistakenly utilized for differentiation in certain conventional applications) may be minimized.

In some applications, the comparator 134 can enhance the training data 136 provided for training or otherwise constructing the classifier 138. In some embodiments, the comparator 134 can identify contrastive pairs, triplets, etc. between the subset of majority class dataset 130 and the minority class dataset 132. The contrastive pairs can be placed adjacently in the same batches of training data 136 to allow for contrastive pairs to be trained simultaneously and emphasize the gradient contrast between the members during the training or construction of the classifier 138. Advantageously, by presenting contrastive pairs in the same batches of training data 136, the relevant degrees of freedom are considered during training, since the contrastive pairs are otherwise similar, easing convergence.

Additionally, in some applications, the comparator 134 can further enhance the training data 136 provided for training or otherwise constructing the classifier 138. In some embodiments, the comparator 134 can identify a contrastive loss term between the contrastive samples. In some embodiments, the comparator 134 can identify a contrastive loss term between the subset of majority class dataset 130 and the minority class dataset 132. Advantageously, the contrastive loss term can be added to existing losses for classification and regularization to focus training on features relevant for classification and ignore spurious features and enhance the constructed classifier 138 by providing an optimal internal representation.

In some applications, the training data 136 is cumulatively enhanced by the preceding steps. For example, in some applications, the comparator 134 may provide the subset of the majority class dataset 130 and the minority class dataset 132 as training data 136. In another example, the comparator 134 may provide the subset of the majority class dataset 130 and the minority class dataset 132, with contrastive pairs of the subset of the majority class dataset 130 and the minority class dataset 132 placed in batches as training data 136. In another example, the comparator 134 may provide the subset of the majority class dataset 130 and the minority class dataset 132, with contrastive pairs of the subset of the majority class dataset 130 and the minority class dataset 132 placed in batches, and a contrastive loss term between the subset of majority class dataset 130 and the minority class dataset 132 as training data 136.

As described herein, the classifier 138 can be trained or otherwise constructed by utilizing the training data 136 provided by the comparator 134. After construction, the classifier 138 can be utilized for any suitable classification task, including but not limited to classifying visual images obtained in any domain, such as RGB, IR, radar, CT, MRI, etc., classifying descriptive text, classifying audio/video signals, classifying multi-dimensional meta-data (being either open or closed set), classifying 3-D images of various formats etc.

The data communicator 140 receives the training data 136 and transmits the training data 136 to one or more computing devices. For example, training data 136 can be transmitted to a server, a cloud-based engine 118, a workstation 124, etc. In some embodiments, transmitting the training data 136 includes causing computing devices to receive training data 136 during construction of a classifier located, stored, executed, or otherwise disposed at a different computing device. In some embodiments, the data communicator receives output from the classifier 138 and transmits the output from the classifier 138.

In some embodiments, training data 136 is generated for one or more models (e.g., machine learning models, deep learning models, statistical models, algorithms, etc.) based on the data and/or input features, etc. One or more models are trained based on corresponding training data. The trained models may be stored in a database, such as in the database 122 (or a cloud storage database).

In some embodiments, the training data computing device 102 assigns the models (or parts thereof) for execution to one or more processing devices 120. For example, each model may be assigned to a virtual machine hosted by a processing device 120. The virtual machine may cause the models or parts thereof to execute on one or more processing units such as GPUs. In some embodiments, the virtual machines assign each model (or part thereof) among a plurality of processing units.

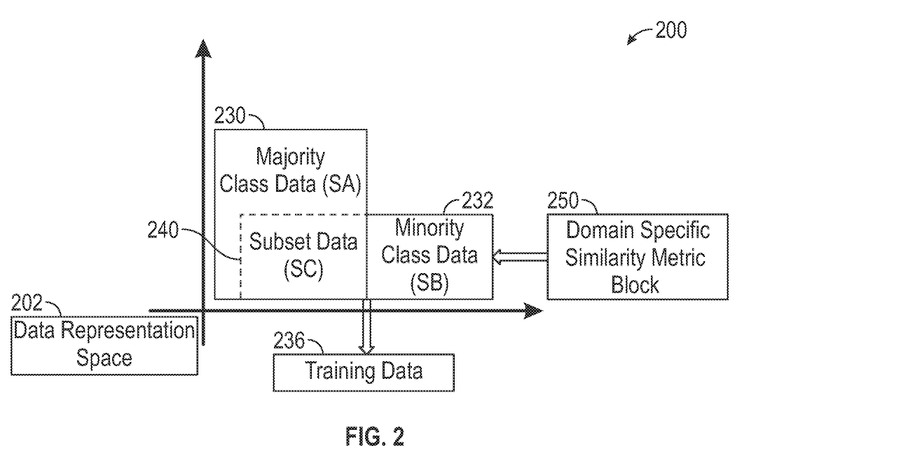

FIG. 2 depicts an example representation 200 of data classes, in accordance with some embodiments. The representation 200 may represent or be implemented by or with any suitable system or device, such as, for example, the training data computing device 102 discussed above with respect to FIG. 1 (including, for example, the comparator 134 and classifier 138, as described below). The representation 200 may be implemented as part of the training data creation process executed by the training data computing device 102.

In the depicted example, the data representation space 202 includes majority class data 230 of class A, denoted by SA and minority class data 232 of class B, denoted by SB. In some embodiments, the data representation space 202 can include any number of majority class data 230 representations and any number of minority class data 232 representations.

As described herein, a system or device, such as the comparator 134 or any suitable external comparison engine, can compare instances of the minority class data 232 of class B to instances of the majority class data 230 of class A to find the most generally similar instance of the majority class A. As illustrated, the most similar instance of the majority class A can be identified as subset data 240 of class A and denoted as SC. As illustrated in the data representation space 202, the subset data 240 (SC) is the same size as the minority class data 232 (SB). In the depicted example, the subset data 240 (SC) and the minority class data 232 (SB) is selected as training data 236 to construct or train a classifier or classification engine.

In some embodiments, contrastive pairs of the subset data 240 (SC) and the minority class data 232 (SB) identified by the comparator 143 or any suitable external comparison engine can be placed in batches or otherwise adjacently in the training data 236. In some applications, a contrastive loss term or domain specific similarity between the subset data 240 (SC) and the minority class data 232 (SB), represented as domain specific similarity metric block 250 can be provided in the training data 236. Advantageously, domain specific similarity metric or contrastive loss term can be added to existing losses for classification and regularization to allow for training to focus on features relevant to classification and ignore spurious features. In some embodiments, the internal representation of training data 236 as depicted in the data representation space 202 can facilitate “easy” final decisions for the constructed classifier 138.

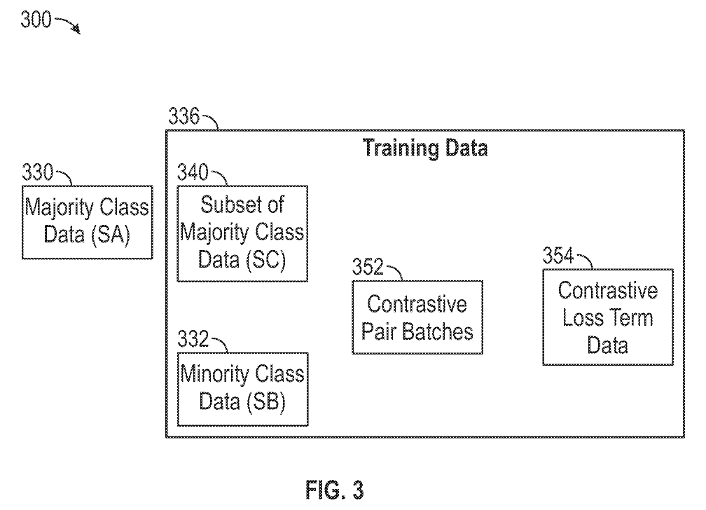

FIG. 3 depicts an example representation 300 of training data 336, in accordance with some embodiments. The representation 300 may represent or be implemented by or with any suitable system or device, such as, for example, the training data computing device 102 discussed above with respect to FIG. 1 (including, for example, the comparator 134 and classifier 138, as described below). The representation 200 may be implemented as part of the training data creation process executed by the training data computing device 102.

In the depicted example, the training data 336 can include the subset of majority class data 340, denoted as (SC) and minority class data 332, denoted as (SB). As described herein, the training data 336 can be balanced, such that training of the classifier 138 does not converge to a general preference of the majority class data 330, denoted as (SA). Further, spurious features of the majority class data 330 may be ignored through the use of the subset of majority class data 340.

In some embodiments, the training data 336 can include contrastive pair batches 352 from the subset of majority class data 340 and the minority class data 332. Further, the training data 354 can include contrastive loss term data 354 corresponding to the contrast between the subset of majority class data 340 and the minority class data 332. As described herein, the inclusion of the contrastive pair batches 352 and/or the contrastive loss term data 354 can further enhance the training data 336.

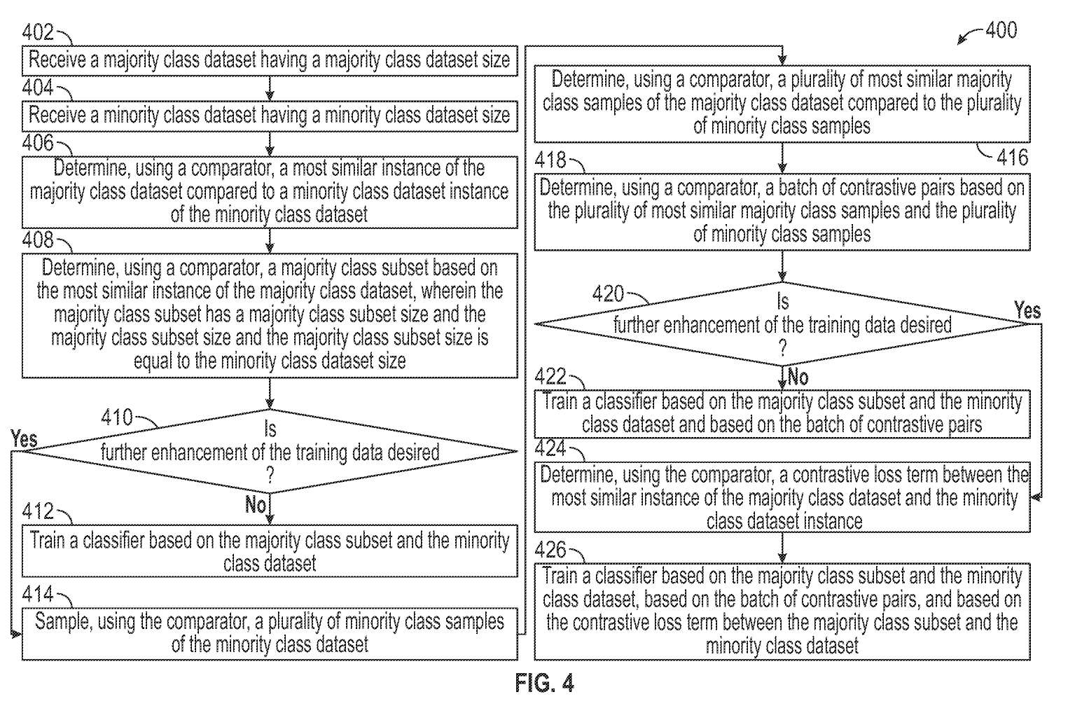

FIGS. 4-6 depict example methods for hosting training data for construction of a classifier, in accordance with some embodiments. In some embodiments, one or more blocks of the methods may be executed substantially concurrently and/or in a different order than shown. In some implementations, a method may include more or fewer blocks than are shown. In some implementations, one or more of the blocks of a method may, at certain times, be ongoing and/or may repeat. In some implementations, blocks of the method may be combined.

The methods shown in FIGS. 4-6 may be implemented in the form of executable instructions stored on machine-readable media and executed by a processing resource and/or in the form of electronic circuitry. For example, aspects of the methods may be described below as being performed by a training data computing device 102, an example of which may be a comparator 134, a classifier 138, etc. running on a hardware processing resource 104 of the training data computing device 102 described above in reference to FIG. 1. Additionally, other aspects of the methods described below may be described with reference to other elements shown in FIG. 1 for non-limiting illustration purposes.

FIG. 4 depicts a flow diagram for hosting example training data for use with a classifier, in accordance with some embodiments. The method 400 includes receiving (402) a majority class dataset having a majority class dataset size. The method 400 includes receiving (404) a minority class dataset having a minority class dataset size. The method 400 includes determining (406) using a comparator, a most similar instances of the majority class dataset compared to a minority class dataset instance of the minority class dataset. The method 400 includes determining (408) using the comparator, a majority class subset based on the most similar instances of the majority class dataset, wherein the majority class subset has a majority class subset size and the majority class subset size is equal to the minority class dataset size.

The method 400 includes determining (410) if further enhancement of the training data is desired. In accordance with a determination that further enhancement of the training data is not desired, the method 400 includes training (412) a classifier based on the majority class subset and the minority class dataset.

In accordance with a determination that further enhancement of the training data is desired, the method 400 includes sampling (414) using the comparator, a plurality of minority class samples of the minority class dataset. Further in accordance with a determination that further enhancement of the training data is desired, the method 400 includes determining (416) using the comparator, a plurality of most similar majority class samples of the majority class dataset compared to the plurality of minority class samples. Further in accordance with a determination that further enhancement of the training data is desired, the method 400 includes determining (418) using the comparator, a batch of contrastive pairs based on the plurality of most similar majority class samples and the plurality of minority class samples.

The method 400 includes determining (420) if further enhancement of the training data is desired. In accordance with a determination that further enhancement of the training data is not desired, the method 400 includes training (422) a classifier based on the majority class subset and the minority class dataset and based on the batch of contrastive pairs.

In accordance with a determination that further enhancement of the training data is desired, the method 400 includes determining (424) using the comparator, a contrastive loss term between paired instances of the majority class subset and the minority class dataset. Further, in accordance with a determination that further enhancement of the training data is desired, the method 400 includes training (426) a classifier based on the majority class subset and the minority class dataset, based on the batch of contrastive pairs, and based on the contrastive loss term between the pairs majority class subset and the minority class dataset.

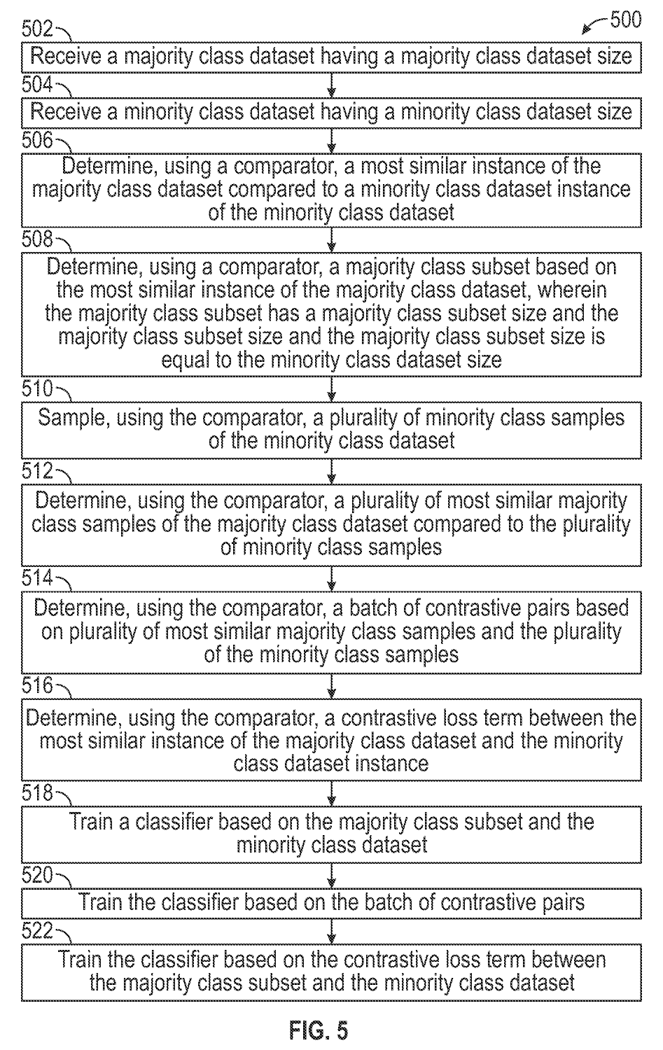

FIG. 5 depicts a flow diagram illustrating an example method for hosting training data for use with a classifier, in accordance with some embodiments. The method 500 starts at operation (502). At operation (502), the method 500 includes receiving a majority class dataset having a majority class dataset size. The method 500 includes operation (504). Operation (504) includes receiving a minority class dataset having a minority class dataset size. The method 500 includes operation (506), which includes determining, using a comparator, a most similar instances of the majority class dataset compared to a minority class dataset instance of the minority class dataset. The method 500 also includes operation (508). Operation (508) includes determining, using the comparator, a majority class subset based on the most similar instances of the majority class dataset, wherein the majority class subset has a majority class subset size and the majority class subset size is equal to the minority class dataset size.

Optionally, the method 500 includes operation (510), which includes sampling, using the comparator, a plurality of minority class samples of the minority class dataset. In some embodiments, if the method 500 includes operation (510), the method 500 further includes operation (512), which includes determining, using the comparator, a plurality of most similar majority class samples of the majority class dataset compared to the plurality of minority class samples. In some embodiments, if the method 500 includes operation (512), method 500 further includes operation (514), which includes determining, using the comparator, a batch of contrastive pairs based on the plurality of most similar majority class samples and the plurality of minority class samples.

Optionally, the method 500 includes operation (516), which includes determining, using the comparator, a contrastive loss term between the pairs from the majority class subset and the minority class dataset.

The method 500 includes operation (518), which includes training a classifier based on the majority class subset and the minority class dataset. In some embodiments, the method 500 ends at operation (518). If the method 500 includes operation (514), the method 500 further includes operation (520), which includes training the classifier based on the batch of contrastive pairs. In some embodiments, the method 500 ends at operation (520). If the method 500 includes operation (516), the method 500 further includes operation (522), which includes training the classifier based on the contrastive loss term between the pairs from the majority class subset and the minority class dataset. In some embodiments, the method 500 ends at operation (522).

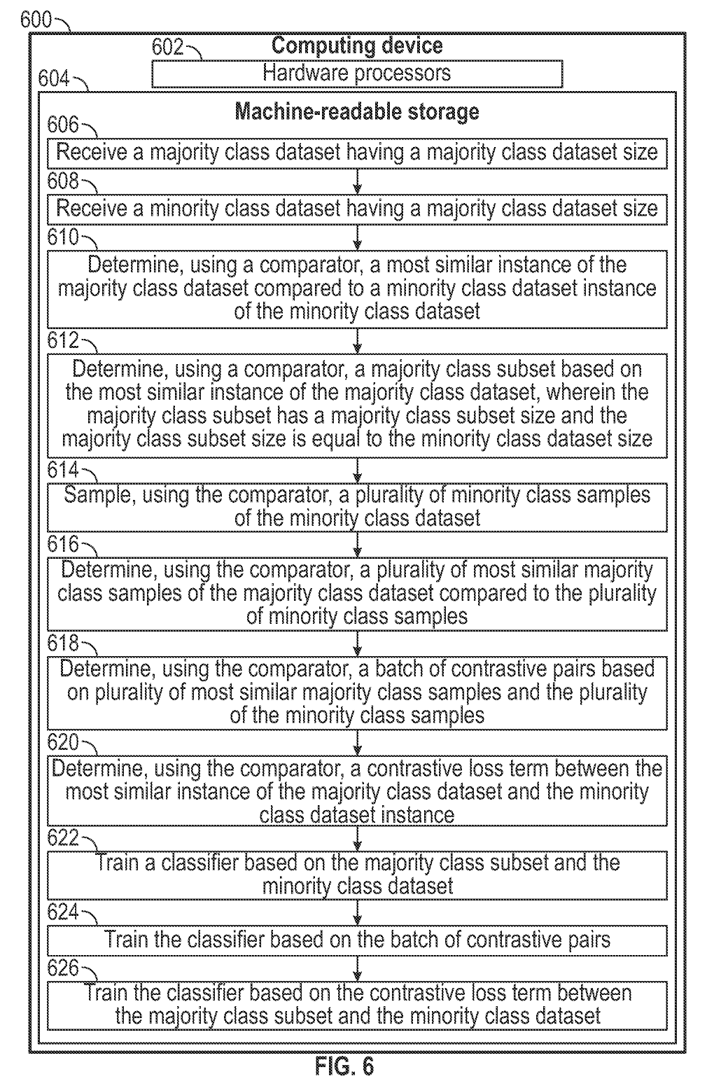

FIG. 6 depicts an example system 600 that includes non-transitory, machine-readable media 604 encoded with example instructions executable by processing resource 602. In some implementations, the system 600 may be useful for implementing aspects of the training data computing device 102 of FIG. 1 and analogous systems. For example, the instructions encoded on machine-readable media 604 may be included in instructions 108 of FIG. 1. In some implementations, functionality described with respect to FIG. 1 may be included in the instructions encoded on machine-readable media 604.

The processing resource 602 may include a microcontroller, a microprocessor, central processing unit core(s), an ASIC, an FPGA, and/or other hardware device suitable for retrieval and/or execution of instructions from the machine-readable media 604 to perform functions related to various examples. Additionally, or alternatively, the processing resource 602 may include or be coupled to electronic circuitry or dedicated logic for performing some or all of the functionality of the instructions described herein.

The machine-readable media 604 may be any medium suitable for storing executable instructions, such as RAM, ROM, EEPROM, flash memory, a hard disk drive, an optical disc, or the like. In some example implementations, the machine-readable media 604 may be a tangible, non-transitory medium. The machine-readable media 604 may be disposed within the system 600 respectively, in which case the executable instructions may be deemed installed or embedded on the system. Alternatively, the machine-readable media 604 may be a portable (e.g., external) storage medium, and may be part of an installation package.

As described further herein below, the machine-readable media 604 may be encoded with a set of executable instructions. It should be understood that part or all of the executable instructions and/or electronic circuits included within one box may, in alternate implementations, be included in a different box shown in the figures or in a different box not shown. Some implementations may include more or fewer instructions than are shown in FIG. 6.

With reference to FIG. 6, the machine-readable media 604 includes instructions 606-626. Instructions 606, when executed, cause the processing resource 602 to receive a majority class dataset having a majority class dataset size. Instructions 608, when executed, cause the processing resource 602 to receive a minority class dataset having a minority class dataset size. Instructions 610, when executed, cause the processing resource 602 to determine a most similar instances of the majority class dataset compared to a minority class dataset instance of the minority class dataset. Instructions 612, when executed, cause the processing resource 602 to determine a majority class subset based on the most similar instances of the majority class dataset, wherein the majority class subset has a majority class subset size and the majority class subset size is equal to the minority class dataset size.

Optionally, instructions 614, when executed, cause the processing resource 602 to sample, using the comparator, a plurality of minority class samples of the minority class dataset. Further optionally, instructions 616, when executed, cause the processing resource 602 to determine a plurality of most similar majority class samples of the majority class dataset compared to the plurality of minority class samples. Further optionally, instructions 618, when executed, cause the processing resource 602 to determine a batch of contrastive pairs based on the plurality of most similar majority class samples and the plurality of minority class samples.

Optionally, instructions 620, when executed, cause the processing resource 602 to determine a contrastive loss term between the pairs of the majority class subset and the minority class dataset.

Instructions 622, when executed, cause the processing resource 602 to train a classifier based on the majority class subset and the minority class dataset. Optionally (e.g. if instructions 618 were previously executed), instructions 624, when executed, cause the processing resource 602 to train the classifier based on the batch of contrastive pairs. Further optionally (e.g. if instructions 620 were previously executed), instructions 626, when executed, cause the processing resource 602 to train the classifier based on the contrastive loss term between the pairs of the majority class subset and the minority class dataset.

In some embodiments, training data is generated for one or more models (e.g., machine learning models, deep learning models, statistical models, algorithms, etc.) based on historical data and features described above in reference to FIGS. 1-3. One or more models are trained based on corresponding training data. The trained models may be stored in a database, such as in a database (e.g., a cloud storage database).

In some embodiments, the training data computing device 102 assigns the models (or parts thereof) for execution to one or more processing devices 120. For example, each model may be assigned to a virtual machine hosted by a processing device 120. The virtual machine may cause the models or parts thereof to execute on one or more processing units such as GPUs. In some embodiments, the virtual machines assign each model (or part thereof) among a plurality of processing units.

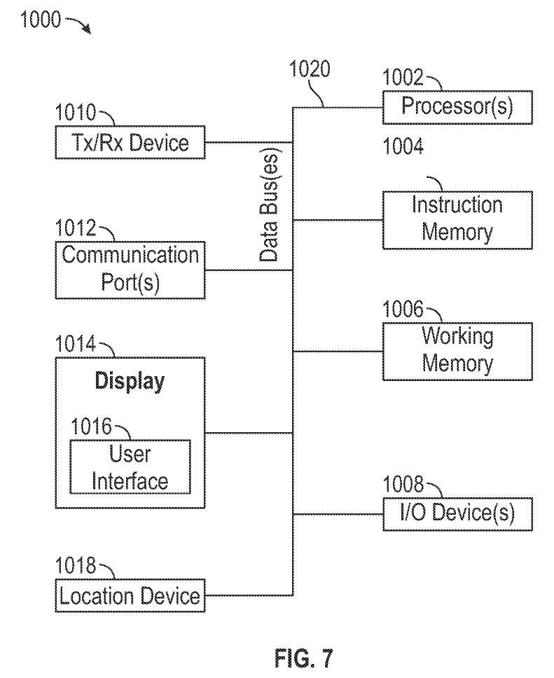

FIG. 7 illustrates a block diagram of a computing device 1000, in accordance with some embodiments. Although FIG. 7 is described with respect to certain components shown therein, it will be appreciated that the elements of the computing device 1000 may be combined, omitted, and/or replicated. In addition, it will be appreciated that additional elements other than those illustrated in FIG. 7 may be added to the computing device.

As shown in FIG. 7, the computing device 1000 may include one or more processing resources 1002, instruction memory 1004, working memory 1006, input/output devices 1008, transceiver 1010, communication ports 1012, display 1014, optional location device 1018, and/or any other suitable elements each operatively coupled to one or more data buses 1020. The data buses 1020 allow for communication among the various components. The data buses 1020 may include wired, or wireless, communication channels.

The one or more processing resources 1002 may include any processing circuitry operable to control operations of the computing device 1000. In some embodiments, the one or more processing resources 1002 include one or more distinct processors, each having one or more cores (e.g., processing circuits). Each of the distinct processors may have the same or different structure. The one or more processing resources 1002 may include one or more central processing units (CPUs), one or more graphics processing units (GPUs), application specific integrated circuits (ASICs), digital signal processors (DSPs), a chip multiprocessor (CMP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The one or more processing resources 1002 may also be implemented by a controller, a microcontroller, an application specific integrated circuit (ASIC), a field programmable gate array (FPGA), a programmable logic device (PLD), etc.

In some embodiments, the one or more processing resources 1002 implement an operating system (OS) and/or various applications. Examples of an OS include, for example, operating systems generally known under various trade names such as Apple macOS™, Microsoft Windows™, Android™, Linux™, and/or any other proprietary or open-source OS. Examples of applications include, for example, network applications, local applications, data input/output applications, user interaction applications, etc.

The instruction memory 1004 may store instructions that are accessed (e.g., read) and executed by at least one of the one or more processing resources 1002. For example, the instruction memory 1004 may be a non-transitory, computer-readable storage medium such as a read-only memory (ROM), an electrically erasable programmable read-only memory (EEPROM), flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. The one or more processing resources 1002 may perform a certain function or operation by executing code, stored on the instruction memory 1004, embodying the function or operation. For example, the one or more processing resources 1002 may execute code stored in the instruction memory 1004 to perform one or more of any function, method, or operation disclosed herein.

Additionally, the one or more processing resources 1002 may store data to, and read data from, the working memory 1006. For example, the one or more processing resources 1002 may store a working set of instructions to the working memory 1006, such as instructions loaded from the instruction memory 1004. The one or more processing resources 1002 may also use the working memory 1006 to store dynamic data created during one or more operations. The working memory 1006 may include, for example, random access memory (RAM) such as a static random access memory (SRAM) or dynamic random access memory (DRAM), Double-Data-Rate DRAM (DDR-RAM), synchronous DRAM (SDRAM), an EEPROM, flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. Although embodiments are illustrated herein including separate instruction memory 1004 and working memory 1006, it will be appreciated that the computing device 1000 may include a single memory unit that operates as both instruction memory and working memory. Further, although embodiments are discussed herein including non-volatile memory, it will be appreciated that computing device 1000 may include volatile memory components in addition to at least one non-volatile memory component.

In some embodiments, the instruction memory 1004 and/or the working memory 1006 includes an instruction set, in the form of a file for executing various methods, such as methods for hosting training data for construction of a classifier. The instruction set may be stored in any acceptable form of machine-readable instructions, including source code or various appropriate programming languages. Some examples of programming languages that may be used to store the instruction set include, but are not limited to: Java, JavaScript, C, C++, C#, Python, Objective-C, Visual Basic, .NET, HTML, CSS, SQL, NoSQL, Rust, Perl, etc. In some embodiments a compiler or interpreter converts the instruction set into machine executable code for execution by the one or more processing resources 1002.

The input/output devices 1008 may include any suitable device that allows for data input or output. For example, the input/output devices 1008 may include one or more of a keyboard, a touchpad, a mouse, a stylus, a touchscreen, a physical button, a speaker, a microphone, a keypad, a click wheel, a motion sensor, a camera, and/or any other suitable input or output device.

The transceiver 1010 and/or the communication port(s) 1012 allow for communication with a network. For example, if a communication network is a cellular network, the transceiver 1010 allows communications with the cellular network. In some embodiments, the transceiver 1010 is selected based on the type of the communication network the computing device 1000 will be operating in. The one or more processing resources 1002 are operable to receive data from, or send data to, a network, via the transceiver 1010.

The communication port(s) 1012 may include any suitable hardware, software, and/or combination of hardware and software that is capable of coupling the computing device 1000 to one or more networks and/or additional devices. The communication port(s) 1012 may be arranged to operate with any suitable technique for controlling information signals using a desired set of communications protocols, services, or operating procedures. The communication port(s) 1012 may include the appropriate physical connectors to connect with a corresponding communications medium, whether wired or wireless, for example, a serial port such as a universal asynchronous receiver/transmitter (UART) connection, a Universal Serial Bus (USB) connection, or any other suitable communication port or connection. In some embodiments, the communication port(s) 1012 allows for the programming of executable instructions in the instruction memory 1004. In some embodiments, the communication port(s) 1012 allow for the transfer (e.g., uploading or downloading) of data, such as machine learning model training data.

In some embodiments, the communication port(s) 1012 couples the computing device 1000 to a network. The network may include local area networks (LAN) as well as wide area networks (WAN) including without limitation Internet, wired channels, wireless channels, communication devices including telephones, computers, wire, radio, optical and/or other electromagnetic channels, and combinations thereof, including other devices and/or components capable of/associated with communicating data. For example, the communication environments may include in-body communications, various devices, and various modes of communications such as wireless communications, wired communications, and combinations of the same.

In some embodiments, the transceiver 1010 and/or the communication port(s) 1012 utilize one or more communication protocols. Examples of wired protocols may include, but are not limited to, Universal Serial Bus (USB) communication, RS-232, RS-422, RS-423, RS-485 serial protocols, FireWire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, etc. Examples of wireless protocols may include, but are not limited to, the Institute of Electrical and Electronics Engineers (IEEE) 802.xx series of protocols, such as IEEE 802.11a/b/g/n/ac/ag/ax/be, IEEE 802.16, IEEE 802.20, GSM cellular radiotelephone system protocols with GPRS, CDMA cellular radiotelephone communication systems with 1xRTT, EDGE systems, EV-DO systems, EV-DV systems, HSDPA systems, Wi-Fi Legacy, Wi-Fi 1/2/3/4/5/6/6E, wireless personal area network (PAN) protocols, Bluetooth Specification versions 5.0, 6, 7, legacy Bluetooth protocols, passive or active radio-frequency identification (RFID) protocols, Ultra-Wide Band (UWB), Digital Office (DO), Digital Home, Trusted Platform Module (TPM), ZigBee, etc.

The display 1014 may be any suitable display, and may display the user interface 1016. The user interfaces 1016 may enable user interaction with the training data computing device. For example, the user interface 1016 may be a user interface for an application of a network environment operator that allows a user to view and interact with the operator’s website. In some embodiments, a user may interact with the user interface 1016 by engaging the input/output devices 1008. In some embodiments, the display 1014 may be a touchscreen, where the user interface 1016 is displayed on the touchscreen.

The display 1014 may include a screen such as, for example, a Liquid Crystal Display (LCD) screen, a light-emitting diode (LED) screen, an organic LED (OLED) screen, a movable display, a projection, etc. In some embodiments, the display 1014 may include a coder/decoder, also known as Codecs, to convert digital media data into analog signals. For example, the visual peripheral output device may include video Codecs, audio Codecs, or any other suitable type of Codec.

The optional location device 1018 may be communicatively coupled to a location network and operable to receive position data from the location network. For example, in some embodiments, the location device 1018 includes a GPS device that receives position data identifying a latitude and longitude from one or more satellites of a GPS constellation. As another example, in some embodiments, the location device 1018 is a cellular device that receives location data from one or more localized cellular towers. Based on the position data, the computing device 1000 may determine a local geographical area (e.g., town, city, state, etc.) of its position.

In some embodiments, the computing device 1000 implements one or more modules or engines, each of which is constructed, programmed, configured, or otherwise adapted, to autonomously carry out a function or set of functions. A module/engine may include a component or arrangement of components implemented using hardware, such as by an application specific integrated circuit (ASIC) or field-programmable gate array (FPGA), for example, or as a combination of hardware and software, such as by a microprocessor system and a set of program instructions that adapt the module/engine to implement the particular functionality that (while being executed) transform the microprocessor system into a special-purpose device. A module/engine may also be implemented as a combination of the two, with certain functions facilitated by hardware alone, and other functions facilitated by a combination of hardware and software. In certain implementations, at least a portion, and in some cases, all, of a module/engine may be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each module/engine may be realized in a variety of physically realizable configurations, and should generally not be limited to any particular example implementation herein, unless such limitations are expressly called out. In addition, a module/engine may itself be composed of more than one sub- modules or sub-engines, each of which may be regarded as a module/engine in its own right. Moreover, in the embodiments described herein, each of the various modules/engines corresponds to a defined autonomous functionality; however, it should be understood that in other contemplated embodiments, each functionality may be distributed to more than one module/engine. Likewise, in other contemplated embodiments, multiple defined functionalities may be implemented by a single module/engine that performs those multiple functions, possibly alongside other functions, or distributed differently among a set of modules/engines than specifically illustrated in the embodiments herein.

In some embodiments, the computing device 1000 may be a computer, a workstation, a laptop, a server such as a cloud-based server, or any other suitable device. In some embodiments, the computing device 1000 is a server that includes one or more processing units, such as one or more graphical processing units (GPUs), one or more central processing units (CPUs), and/or one or more processing cores. The computing device 1000 may, in some embodiments, execute one or more virtual machines. In some embodiments, processing resources (e.g., capabilities) of the computing device 1000 are offered as a cloud-based service (e.g., cloud computing).

Although embodiments are illustrated herein including certain systems and/or devices, it will be appreciated that additional systems, servers, storage mechanism, etc. may be included. In addition, although embodiments are illustrated herein having individual, discrete systems, it will be appreciated that, in some embodiments, one or more systems may be combined into a single logical and/or physical system. Similarly, although embodiments are illustrated having a single instance of each device or system, it will be appreciated that additional instances of a device may be implemented. In some embodiments, two or more systems may be operated on shared hardware in which each system operates as a separate, discrete system utilizing the shared hardware, for example, according to one or more virtualization schemes.

In some embodiments, by training models based on training data, the trained function is able to adapt to new circumstances and to detect and extrapolate patterns. In general, parameters of a trained function may be adapted by means of training. In particular, a combination of supervised training, semi-supervised training, unsupervised training, reinforcement learning and/or active learning may be used. Furthermore, representation learning (an alternative term is “feature learning”) may be used. In particular, the parameters of the trained functions may be adapted iteratively by several steps of training.

It will be appreciated that training data generated by the training data computing device 102 is based on datasets disclosed herein, particularly on large datasets intended to be used with comparator 134 and classifier 138 (or other components of the training data computing device 102), are only possible with the aid of computer-assisted machine-learning algorithms and techniques. In some embodiments, machine learning processes are used to perform operations that cannot practically be performed by a human, either mentally or with assistance. It will be appreciated that a variety of machine learning techniques can be used alone or in combination to host training data for construction of a classifier, etc.

Although the subject matter has been described in terms of example embodiments, it is not limited thereto. Rather, the appended claims should be construed broadly, to include other variants and embodiments that may be made by those skilled in the art.

What is claimed is:

1. A system, comprising:
a processor; and
a non-transitory memory storing instructions, that when executed, cause the processor to:
receive a majority class dataset having a majority class dataset size;
receive a minority class dataset having a minority class dataset size, wherein the minority class dataset size is smaller than the majority class dataset size;
determine, using a comparator, a most similar instance of the majority class dataset compared to a minority class dataset instance of the minority class dataset;
determine, using the comparator, a majority class subset based on the most similar instance of the majority class dataset, wherein the majority class subset has a majority class subset size and the majority class subset size is equal to the minority class dataset size; and
train a classifier based on the majority class subset and the minority class dataset.

2. The system of claim 1, wherein the instructions, when executed, further cause the processor to:
sample, using the comparator, a plurality of minority class samples of the minority class dataset; and
determine, using the comparator, a plurality of most similar majority class samples of the majority class dataset compared to the plurality of minority class samples.

3. The system of claim 2, wherein the instructions, when executed, further cause the processor to:
determine, using the comparator, a batch of contrastive pairs based on the plurality of most similar majority class samples and the plurality of minority class samples.

4. The system of claim 3, wherein the instructions, when executed, further cause the processor to:
train the classifier based on the batch of contrastive pairs.

5. The system of claim 4, wherein the instructions, when executed, further cause the processor to:
determine, using the comparator, a contrastive loss term for each pair within the batch of contrastive pairs.

6. The system of claim 5, wherein the instructions, when executed, further cause the processor to:
train the classifier based on the contrastive loss term for each pair within the batch of contrastive pairs.

7. The system of claim 1, wherein the instructions, when executed, further cause the processor to:
determine, using the comparator, a contrastive loss term between the most similar instance of the majority class dataset and the minority class dataset instance; and
train the classifier based on the contrastive loss term between the majority class subset and the minority class dataset.

8. The system of claim 1, wherein the instructions, when executed, further cause the processor to:
receive a plurality of minority class datasets each having a respective minority class dataset size, wherein the respective minority class dataset size is smaller than the majority class dataset size;
determine, using the comparator, a plurality of most similar instances of the majority class dataset compared to a plurality of minority class datasets instances of the plurality of minority class datasets;
determine, using the comparator, a plurality of majority class subsets based on the plurality of most similar instances of the majority class dataset, wherein the plurality of majority class subsets each has a respective majority class subset size and the respective majority class subset size is equal to the respective minority class dataset size of the plurality of minority class datasets; and
train the classifier based on the plurality of majority class subsets and the plurality of minority class datasets.

9. A computer-implemented method, comprising:
receiving a majority class dataset having a majority class dataset size;
receiving a minority class dataset having a minority class dataset size, wherein the minority class dataset size is smaller than the majority class dataset size;
determining a most similar instance of the majority class dataset compared to a minority class dataset instance of the minority class dataset;
determining a majority class subset based on the most similar instances of the majority class dataset, wherein the majority class subset has a majority class subset size and the majority class subset size is equal to the minority class dataset size; and
training a classifier based on the majority class subset and the minority class dataset.

10. The computer-implemented method of claim 9, further comprising:
sampling a plurality of minority class samples of the minority class dataset; and
determining a plurality of most similar majority class samples of the majority class dataset compared to the plurality of minority class samples.

11. The computer-implemented method of claim 10, further comprising:
determining a batch of contrastive pairs based on the plurality of most similar majority class samples and the plurality of minority class samples; and
training the classifier based on the batch of contrastive pairs.

12. The computer-implemented method of claim 11, further comprising:
determining a contrastive loss term for for each pair within the batch of contrastive pairs; and
training the classifier based on the contrastive loss term for the batch of contrastive pairs.

13. The computer-implemented method of claim 9, further comprising:
determining a contrastive loss term between the most similar instance of the majority class dataset and the minority class dataset instance; and
training the classifier based on the contrastive loss term between the majority class subset and the minority class dataset.

14. The computer-implemented method of claim 9, further comprising:
receiving a plurality of minority class datasets each having a respective minority class dataset size, wherein the respective minority class dataset size is smaller than the majority class dataset size;
determining, a plurality of most similar instances of the majority class dataset compared to a plurality of minority class datasets instances of the plurality of minority class datasets;
determining, a plurality of majority class subsets based on the plurality of most similar instances of the majority class dataset, wherein the plurality of majority class subsets each has a respective majority class subset size and the respective majority class subset size is equal to the respective minority class dataset size of the plurality of minority class datasets; and
training the classifier based on the plurality of majority class subsets and the plurality of minority class datasets.

15. A non-transitory computer readable medium having instructions stored thereon, wherein the instructions, when executed by at least one processor, cause at least one device to perform operations comprising:
receiving a majority class dataset having a majority class dataset size;
receiving a minority class dataset having a minority class dataset size, wherein the minority class dataset size is smaller than the majority class dataset size;
determining, using a comparator, a most similar instance of the majority class dataset compared to a minority class dataset instance of the minority class dataset;
determining, using the comparator, a majority class subset based on the most similar instance of the majority class dataset, wherein the majority class subset has a majority class subset size and the majority class subset size is equal to the minority class dataset size; and
training a classifier based on the majority class subset and the minority class dataset.

16. The non-transitory computer readable medium of claim 15, wherein the instructions, when executed by the at least one processor, cause the at least one device to perform operations further comprising:
sampling, using the comparator, a plurality of minority class samples of the minority class dataset; and
determining, using the comparator, a plurality of most similar majority class samples of the majority class dataset compared to the plurality of minority class samples.

17. The non-transitory computer readable medium of claim 16, wherein the instructions, when executed by the at least one processor, cause the at least one device to perform operations further comprising:
determining, using the comparator, a batch of contrastive pairs based on the plurality of most similar majority class samples and the plurality of minority class samples; and
training the classifier based on the batch of contrastive pairs.

18. The non-transitory computer readable medium of claim 17, wherein the instructions, when executed by the at least one processor, cause the at least one device to perform operations further comprising:
determining, using the comparator, a contrastive loss term for each pair within the batch of contrastive pairs; and
training the classifier based on the contrastive loss term for the batch of contrastive pairs.

19. The non-transitory computer readable medium of claim 15, wherein the instructions, when executed by the at least one processor, cause the at least one device to perform operations further comprising:
determining, using the comparator, a contrastive loss term between the most similar instance of the majority class dataset and the minority class dataset instance; and
training the classifier based on the contrastive loss term between the majority class subset and the minority class dataset.

20. The non-transitory computer readable medium of claim 15, wherein the instructions, when executed by the at least one processor, cause the at least one device to perform operations further comprising:
receiving a plurality of minority class datasets each having a respective minority class dataset size, wherein the respective minority class dataset size is smaller than the majority class dataset size;
determining, using the comparator, a plurality of most similar instances of the majority class dataset compared to a plurality of minority class datasets instances of the plurality of minority class datasets;
determining, using the comparator, a plurality of majority class subsets based on the plurality of most similar instances of the majority class dataset, wherein the plurality of majority class subsets each has a respective majority class subset size and the respective majority class subset size is equal to the respective minority class dataset size of the plurality of minority class datasets; and
training the classifier based on the plurality of majority class subsets and the plurality of minority class datasets.
